(19) United States
(12) Patent Application Publication
(10) Pub. No.: US 2019/0376295 A1
(43) Pub. Date: Dec. 12, 2019

(54) PNEUMATIC ROOFING MATERIAL REMOVAL TOOL

(71) Applicant: James Richard Kingham, Dewey, AZ (US)

(72) Inventor: James Richard Kingham, Dewey, AZ (US)

(21) Appl. No.: 16/001,881

(22) Filed: Jun. 6, 2018

(51) Int. Cl. E04D 15/00; E04D 15/04

(52) U.S. Cl. CPC E04D 15/003; B25D 9/04; E04D 15/04

(57) ABSTRACT

A pneumatic roofing material removal tool includes a single-acting pneumatic cylinder with a heavy piston for driving a blade under roofing materials and fasteners to detach them from a roof. The blade is connected to a driver having a blade end and an anvil end. Impacts upon the driver are transmitted to the blade, the driver and the blade being in rigidly fixed relationship. The single-acting pneumatic cylinder applies a forceful impact to the anvil end of the driver sufficient to move the driver and the attached blade under the roofing materials, and towards at least one fastener. Also included is a frame that slidably supports the driver and handle assembly, the frame also fixedly supporting the single-acting pneumatic cylinder. The roofing material removal tool increases the speed, ease, and efficiency of removing old roofing materials from a roof, and increases safety, while reducing physical labor and risk of injury.

### FIELD OF THE INVENTION

This invention relates generally to powered roofing tools, and more particularly to powered roofing tools for removing roofing materials.

### BACKGROUND OF THE INVENTION

Removing old roofing materials from a roof is a common part of home maintenance and repair. Typically, old shingles, nails, and other fasteners are removed when replacing a roof's shingles. In addition, underlying roofing materials are often removed before applying new replacement shingles, such as felt, nails, and the old shingles. The old roofing materials are traditionally removed by prying off the old shingles, nails, and other materials by using a manual tool, such as a roofing removal shovel, spade, or fork. These manual tools have a handle and a blade with a fulcrum that is used to pry shingles and nails from the roof surface.

Manual tools require a roofer to use great physical labor. The roofer's shoulders, arms, legs, and feet must exert enough force to dislodge the nails and other fasteners from the roof, and to pry the roofing materials away from the roof surface for disposal. For shingles and fasteners that are among the most resistant to removal, the roofer must often use his/her feet to apply a force of sufficient impact to push the shingle removal tool under the shingles and nails before prying off the old roofing material.

When using a manual roofing tool, the roofer will use his/her arm and shoulder muscles to move the manual tool with sufficient force to get the light-weight roofing shovel under the roofing nails. Typically, the roofer will use his/her muscles to shove the blade under the shingles at a high speed to provide sufficient momentum to the light-weight manual tool to overcome the resistance from the roofing materials, and to move the manual tool to reach under and around the nails. When the manual blade hits a nail, the manual blade will stop suddenly, and the roofer may experience a sharp pain that travels up to the roofer's shoulder. Because of overuse injuries to the arms and shoulders of the roofer using a manual roofing tool, it is not unusual to find roofers who have had shoulder surgery.

In addition, when manipulating the roofing tool with their feet, the roofer is exposed to a safety hazard, since the roofer can lose his/her sure-footedness and balance, and the roofer may fall on the roof surface, or even fall from the roof.

Other work-related Injuries are common when using manual tools to remove roofing materials. Overuse injuries to the roofer's joints, tendons, and muscles can be caused by the roofing tools striking against roofing nails, and by the resulting impacts being transmitted to the roofer's body.

An example of a manual tool that became popular among roofers during the 1980's is the Shingle Eater®, sold by Shingle Eater, Inc., 16 Jones Creek Drive, Scarborough, Me. 04074. This lightweight manual tool includes a reinforced blade, the blade having a plurality of teeth for gripping roofing nails. However, since this tool is manual, the user risks overuse injuries, such as injuries to the roofer's joints, tendons, and muscles.

Willis, U.S. Pat. No. 7,313,985 B2 teaches a powered tool for the removal of shingles and nails from a roof using a blade, with the blade's motion being powered by an air cylinder using compressed air. However, the air cylinder moves the blade in a substantially up and down motion, and the air cylinder is not configured to move the blade forward with enough forceful impact to wedge the blade under the shingles, under-layers, and nails. Because of this, the roofer must often use their own feet to push the entire device forward so that the blade has sufficient forceful impact to penetrate under the shingles, under-layers, and nails. Therefore, by using their feet, the roofer is at risk of losing their sure-footedness and balance on the roof's surface, creating a safety hazard for the roofer. In addition, the device of U.S. Pat. No. 7,313,985 B2 is recommended for use on roofs with pitch of 4/12 or shallower. However, many rooves have a pitch greater than 4/12. The device of U.S. Pat. No. 7,313,985 B2 cannot be safely used on steeper rooves. If the device is used on a steep roof, the device may become unstable and tip over, possibly causing injury to the operator or others.

### SUMMARY OF THE INVENTION

The pneumatic roofing material removal tool of the invention provides a solution to the problem of the removal of roof shingles, reducing the risk of overuse injury as compared with known manual tools, and reducing the risk of falling off the roof while working on the roof, as compared with known manual tools.

The pneumatic roofing material removal tool of the invention provides powered assistance in the removal of old shingles, nails, fasteners, and other old roofing materials by using a pneumatically powered impact to drive a blade so as to penetrate under the shingles, under-layers, and nails. With traditional roofing material removal tools, the roofer must frequently use his/her feet to kick the rear of the tool to push the blade of the tool forward and under the shingles and nails, thereby using their feet to provide the impact to remove the shingles and nails. By contrast, the pneumatic roofing material removal tool of the invention uses a pneumatic air cylinder to provide a powerful impact to rapidly shove the blade of the tool under the shingles and nails.

The pneumatically powered blade of the roofing material removal tool of the invention requires much less physical exertion compared to hand-operated roofing removal tools. In addition, the sliding suspension of the pneumatic roofing material removal tool of the invention absorbs much of the physical impact shock due to impacts of the blade when striking nails and other fasteners, thereby isolating the roofer's body from these shocks. Reducing both physical exertion and physical impacts to the body can reduce overuse injuries to the roofer's joints, tendons, and muscles.

The pneumatic roofing material removal tool of the invention includes a pneumatically powered blade that forcefully surges forward to wedge under the old shingles, and to impact upon nails, and other materials, dramatically reducing the effort needed when compared to manual tools. In addition, the power-assisted forward impactful motion increases the speed of removal of the old shingle materials when compared to manual tools, enabling the roofer to remove the old shingles, nails, and other materials in a fraction of the time required for manual roofing removal tools.

The pneumatic roofing material removal tool of the invention further reduces the effort required by the roofer since, after the roofer has begun to lift shingles and nails with a first press of the push-button that activates the air cylinder of the tool, the roofer can leave the blade in place under some roofing material, and then push the push-button again, thereby re-activating the tool to quickly and forcefully move the blade forward even more so as to drive the blade further under the roofing material. Therefore, simply by pushing the push-button more than once while the blade is under particular roofing material, the roofer can easily apply repeated forward-motion blows to the blade before lifting the materials from the roof, thereby avoiding the extra effort needed to retract the blade manually after each manual forward thrust of the blade, and then working to manually reinsert the blade, as is commonly done with traditional roofing removal tools.

The pneumatic roofing material removal tool of the invention is a relatively light-weight tool that can be used on any pitch roof. The tool is very versatile, and so it can be used in many ways. A roofer can use the pneumatic roofing material removal tool of the invention to go under shingles and up the slope of the roof. It is particularly useful when removing the shingles on the roof cap. In addition, it can be used to remove rows of shingles (called “courses of shingles”) starting from a top shingle row, and moving through the rows downward, or the roofer can peel courses of shingles off the roof by moving with a sideways motion.

This tool gives the roofer the power on demand needed to effectively engage with the roofing materials so as to remove them efficiently, without damaging the muscles and tendons of the roofer. The tool of the invention uses high pressure air from an external air compressor to provide forceful impacts that enable the blade of the tool to shove under the roofing materials that need to be removed. The roofer only has to guide the tool, tilt the tool as needed to pry the nails out of the roof, and then simply sweep the loosened shingles and nails away from the roof. Thus, the pneumatic air cylinder does much of the work that the roofer did when using traditional manual roofing material removal tools.

In addition, the pneumatic roofing material removal tool of the invention requires only the roofer's hands to operate. Since the roofer's feet are not used, the roofer can keep both feet planted firmly on the surface of the roof at all times, thereby maintaining the roofer's sure-footedness and balance while standing on the roof, which increases the roofer's safety while using the tool.

Therefore, the pneumatic roofing material removal tool of the invention increases the speed, ease, and efficiency of removing old roofing materials from a roof, thereby reducing the roofer's physical labor, while also reducing the risk of injury, and increasing the roofer's safety.

A general aspect of the invention is a pneumatic roofing material removal tool for use by a roofer when removing roofing material from a roof. The tool includes: a blade configured to be wedged under at least one layer of roofing material; a driver having a blade end and an anvil end, the blade end of the driver being rigidly connected to the blade, such that any impacts upon the anvil end of the driver are transmitted to the blade via the blade end of the driver; a single-acting pneumatic cylinder configured to apply forceful impacts to the anvil end of the driver; a handle assembly configured to be gripped by a user; and a frame having: an upper portion in slidable relationship with the handle assembly, and a lower portion slidably supporting the driver, and fixedly supporting the single-acting pneumatic cylinder.

In some embodiments, the lower portion of the frame includes at least two lower bushings that slidably support the driver.

In some embodiments, the lower portion of the frame includes at least one spring configured to resiliently absorb energy of forward motion of the driver after impact, and then reverse the forward motion of the driver.

In some embodiments, the driver has a rearward motion stop that is configured to limit the rearward motion of the driver.

In some embodiments, the upper portion of the frame includes at least two upper bushings that slidably support the handle assembly.

In some embodiments, the handle assembly includes at least one beam with a non-circular cross section disposed within the at least two upper bushings.

In some embodiments, the handle assembly includes at least one recoil-absorbing spring configured to resiliently absorb rearward motion of the frame.

In some embodiments, the handle assembly has a rearward motion stop that is configured to limit rearward motion of the handle assembly.

In some embodiments, the frame has at least one mounting fixture for at least one air control valve.

In some embodiments, the single-acting pneumatic cylinder includes: a piston weighing at least 0.5 pounds.

In some embodiments, the tool further includes: a pneumatic accumulator configured to store high pressure air, the pneumatic accumulator being in fluid communication with the single-acting pneumatic cylinder. In further embodiments, at least some part of the lower portion of the frame functions as the pneumatic accumulator.

In some embodiments, the frame includes a collision protection box that at least partially encloses the anvil end of the driver.

In some embodiments, the single-acting pneumatic cylinder is mounted onto the frame with vibration-absorbing mounts, made of at least one of: rubber, silicone, or elastic plastic.

In some embodiments, the blade has a plurality of teeth.

In some embodiments, the blade is removable.

In some embodiments, the blade has a fulcrum-shaped base.

In some embodiments, the blade is shaped so as to include a fulcrum that enables the blade to be used to pry up roofing materials.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a perspective view showing an embodiment of the pneumatic roofing material removal tool with a pneumatic accumulator.

FIG. 2 is a perspective close-up view of the embodiment of FIG. 1.

FIG. 3 is a perspective close-up view of the embodiment of FIG. 1, also showing the U-shaped pneumatic cylinder mounting bracket and the collision protection box.

FIG. 4 is a top cross-sectional view of the lower portion of the frame and the collision protection box of FIG. 3, showing the attachment of both the U-shaped pneumatic cylinder mounting bracket and the collision protection box to the lower portion of the frame.

FIG. 5 is a cross-sectional view of a single acting pneumatic cylinder having a heavy internal piston weight and an internal restoring spring.

FIG. 6A is a perspective bottom view of an embodiment of a blade with a fulcrum-shaped base and a longer lever arm.

FIG. 6B is a side view of the embodiment FIG. 6A, shown on a roof surface.

FIG. 7A is a perspective bottom view of an alternative embodiment of a blade with a fulcrum-shaped base and a shorter lever arm.

FIG. 7B is a side view of the embodiment of FIG. 7A, shown on a roof surface.

FIG. 8A is a side view of the embodiment of the pneumatic roofing material removal tool of FIG. 1 having the blade of FIG. 7A, shown positioned on the roof surface, also showing the air cylinder piston rod in a retracted position, and the air cylinder piston rod-to-anvil acceleration distance.

FIG. 8B is a side view of the embodiment of FIG. 8A, showing the air cylinder piston rod in a partially extended position, with the air cylinder piston rod in contact with the anvil end of the driver, and the blade making contact with the first nail.

FIG. 8C is a side view of the embodiment of FIG. 8B, showing the air cylinder piston rod in a partially extended position, showing the pneumatic roofing material removal tool tilted downward, and the blade tilted upward after having pried the first nail partially out.

FIG. 8D is a side view of the embodiment of FIG. 8C, showing the air cylinder piston rod in a fully extended position, showing the first nail fully pried out and the blade making contact with the second nail.

FIG. 8E is a side view of the embodiment of FIG. 8D, showing the air cylinder piston rod in a fully extended position, showing the pneumatic roofing material removal tool tilted downward, and the blade tilted upward after having pried the second nail fully out.

### DETAILED DESCRIPTION

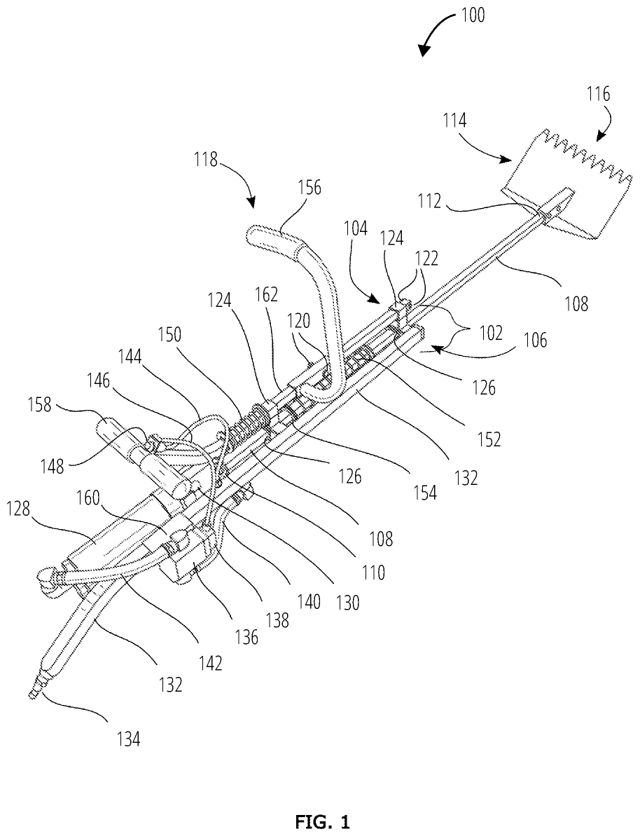

With reference to FIG. 1, a perspective view is shown of an embodiment of a pneumatic roofing material removal tool 100 having a pneumatic accumulator 132.

The pneumatic roofing material removal tool 100 includes a frame 102 having an upper portion 104 and a lower portion 106. The lower portion 106 slidably supports a driver 108 that is rigidly attached to a blade 114.

The driver 108 includes an anvil end 110 and a blade end 112. In this embodiment, the blade 114 has a plurality of teeth 116. The driver 108 is slidably supported by at least two lower bushings 126 that are part of the lower portion 106 of the frame 102. The lower portion 106 of the frame 102 also fixedly supports a single acting pneumatic cylinder 128.

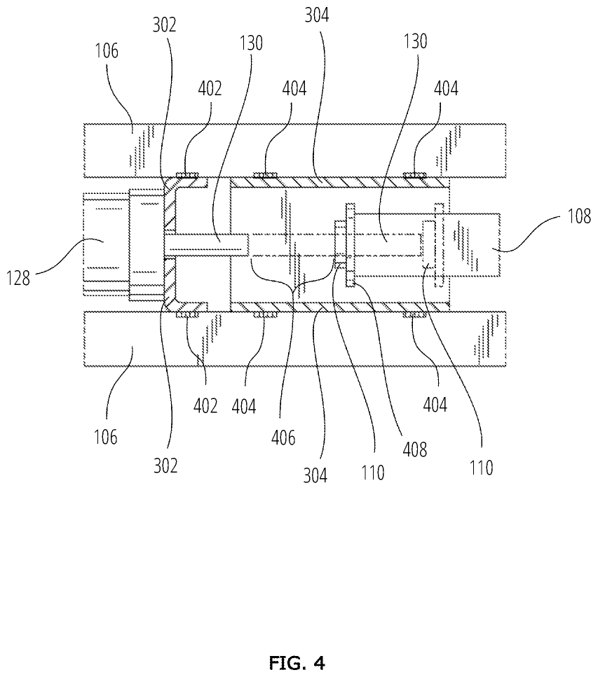

The lower portion 106 of the frame 102 includes the pneumatic accumulator 132 as being part of the lower portion 106. In some embodiments, the pneumatic accumulator 132 is wider than the parallel member of the lower portion 106 of the frame 102. Alternatively, the pneumatic accumulator 132 can be equal in width as compared with the parallel member of the lower portion 106 of the frame 102, as shown in FIG. 4 below. Further, the length of the pneumatic accumulator 132 can be longer than the parallel member of the lower portion 106 of the frame 102, as shown in FIG. 1. Of course, the length of the pneumatic accumulator 132 can be longer or shorter than what is shown in FIG. 1.

Alternatively, instead of using a single acting pneumatic cylinder 128, a double acting pneumatic cylinder could be used. A double acting pneumatic cylinder uses pressurized air for the restoring force that retracts the piston, whereas a single acting pneumatic cylinder uses a return spring to provide the restoring force to retract the piston.

The upper portion 104 slidably supports a handle assembly 118 that includes a forward handle 156 and a rear handle 158, each attached to a support rod 162. The forward handle 156 is attached to the support rod 162 by a handle assembly attachment bolt 120. Rearward motion of the support rod 162 of the handle assembly 118 is limited by a rearward motion stop 122. The support rod 162 of the handle assembly 118 is slidably supported by at least two upper bushings 124 that are part of the upper portion 104 of the frame 102.

A quick-connect air fitting 134 receives high pressure air from an external high pressure air compressor, supplied through an air compressor hose (not shown). In this embodiment, the high pressure air passes through the quick-connect air fitting 134 and enters the pneumatic accumulator 132. The pneumatic accumulator 132 acts as a high pressure air storage reservoir. A main air feed hose 140 provides high pressure air from the pneumatic accumulator 132 to an air control valve 136. A pilot feed tube 144 also provides high pressure air from the pneumatic accumulator 132 to a push-button valve 148.

The push-button valve 148 controls the flow of air from the pilot feed tube 144 to a pilot activation tube 146. When a user depresses the push-button valve 148, a small amount air is permitted to flow from the pilot feed tube 144 to the pilot activation tube 146, thereby activating a pilot valve 138.

Therefore, when the user depresses the push-button valve 148, the pilot valve 138 activates the air control valve 136, which provides a large amount of high pressure air to the single acting pneumatic air cylinder 128.

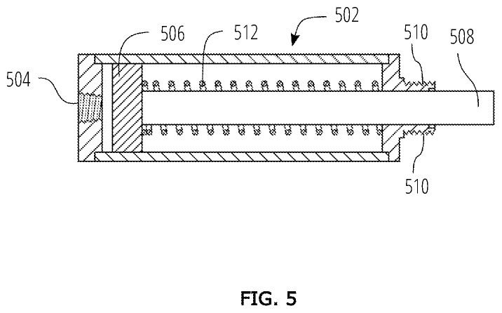

The air control valve 136 is configured to allow high pressure air to flow from the pneumatic accumulator 132 through the air control valve 136 and an air cylinder hose 142 to the single acting pneumatic cylinder 128, thereby pushing forward an air cylinder piston rod 130 with a very powerful pneumatic force that also compresses the internal restoring spring 512 (shown in FIG. 5) of the single acting pneumatic cylinder 128. The air cylinder piston rod 130 remains forward until the user releases the push-button valve 148.

When the push-button valve 148 is released, the air control valve 136 quickly shuts off the supply of air to the air cylinder hose 142, and high pressure air from the single acting pneumatic cylinder 128 is exhausted rapidly back through the air cylinder hose 142.

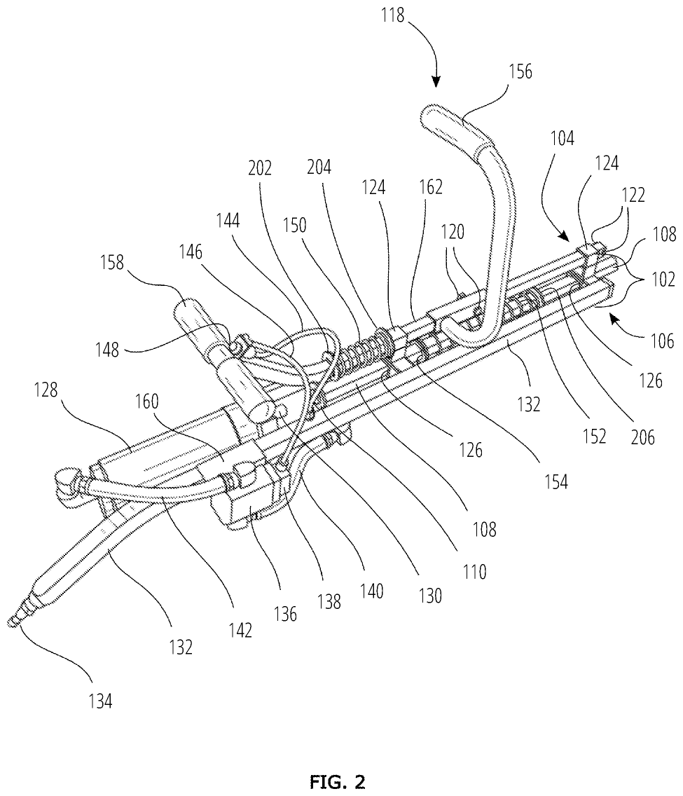

The mounting fixture 160, a recoil-absorbing spring 150, a driver rearward motion stop 154, and an energy absorbing spring 152 will be explained below with reference to the close-up view of FIG. 2.

With reference to FIG. 2, a perspective close-up view of the embodiment of FIG. 1 is shown of the pneumatic roofing material removal tool 100, without showing the blade end of the driver 112 and the blade 114 (both shown in FIG. 1).

This embodiment includes the single acting pneumatic cylinder 128. In the single acting pneumatic cylinder 128, high pressure air forces the air cylinder piston rod 130 to a forward position during an extending stroke, while an internal restoring spring 512 (shown in FIG. 5) returns the air cylinder piston rod 130 to the rearward position during a retracting stroke.

The single acting pneumatic cylinder 128 includes a heavy internal piston 506 (shown in FIG. 5). For example, the weight of this heavy internal piston 506 is 0.5 pounds for the 2 inch bore air cylinder which can use a 0.5 pound brass piston, or 0.75 pounds for the brass piston which can be used in a 2.5 inch bore cylinder.

Further, the weight of the shaft is 2.12 pounds, for example.

The stroke length can be 2 or 3 inches, depending on the application. Using a 3 inch stroke length will cover a broad range of applications. Note that the weight of the piston is small in comparison to the weight of the shaft, so the use of a heavy piston is optional when using an air cylinder that has a shaft of a weight greater than 2 pounds. Of course, increasing the air pressure of the compressor will compensate for the lesser moving mass of a lighter piston and shaft assembly.

An air control valve 136 is attached to the frame 102 using at least one mounting fixture 160. The air control valve 136 both prevents and permits the flow of high pressure air from the main air feed hose 140 to an air cylinder hose 142. When the user depresses the push-button valve 148 mounted on the rear handle 158, the pilot valve 138 is activated, and the air control valve 136 permits the flow of high pressure air from the main air feed hose 140 to the air cylinder hose 142, and the high pressure air then enters the single acting pneumatic cylinder 128.

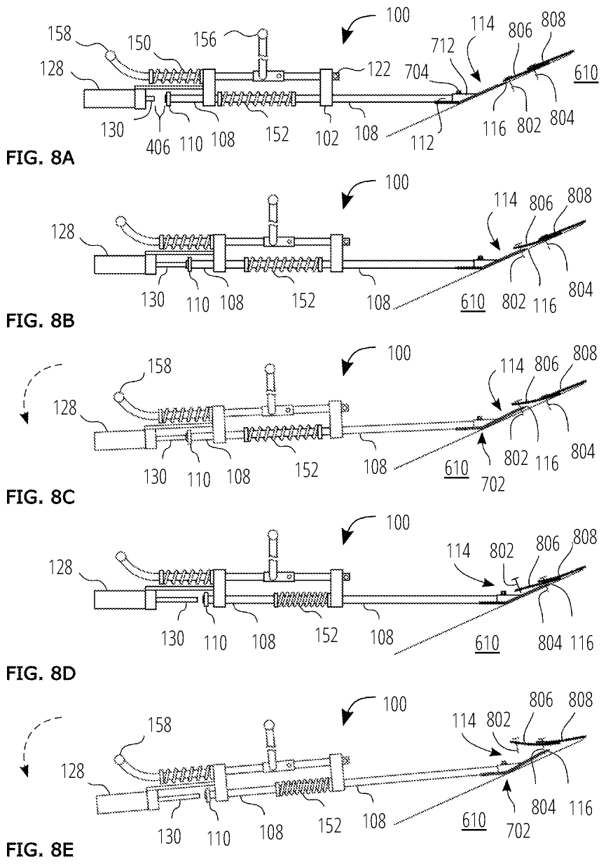

During the extending stroke, as the high pressure air enters through the air cylinder hose 142 into the single acting pneumatic cylinder 128, the air cylinder piston rod 130 moves toward the anvil end 110 of the driver 108, and applies a powerful impact to the anvil end 110 of the driver 108. Typically, this powerful impact rapidly accelerates the driver 108 and the blade 114 (shown in FIG. 1) forward, and rapidly and forcefully shoves the blade 114 under at least one layer of roofing material (See FIGS. 8A and 8B, for example).

If the user maintains the push-button valve 148 in an open state, the high pressure air will continue to pass through the air cylinder hose 142 and into the single acting pneumatic cylinder 128, and the air cylinder piston rod 130 will be maintained in an extended position, thereby maintaining the anvil end 110 of the driver 108 and the blade 114 in a forward position (shown in FIG. 8B through FIG. 8E).

The handle assembly 118 includes the recoil-absorbing spring 150 for resiliently absorbing the energy of the rearward recoil motion of the frame 102. For example, when the blade hits a nail that stops forward motion of the blade, the anvil end 110 of the driver 108 will not move forward when the air cylinder rod 130 strikes the anvil end 110, thereby thrusting the frame 102 and the air cylinder 128 backwards, and the recoil-absorbing spring 150 will absorb the energy of the backward motion of the frame 102 and the air cylinder 128. The handle 156 is decoupled from the frame by the recoil-absorbing spring 150, so the recoil felt by the user grasping the handle 156 is minimized.

On the handle stem 162 the washer 202 behind the spring 150 is a stop washer 202 that is fixed in position, the washer 204 forward of the spring, is a spring retainer washer 204 that slides on the handle stem 162, it has a flat surface for the spring 150 to collapse against.

As the user pushes forward against the handle assembly 118 while the blade 114 presses against roofing material to be removed, the frame 102 moves forward relative to the driver 108 and the blade 114. This forward movement of the frame 102 brings the relative position of the anvil end 110 of the driver 108 rearward, until the anvil end 110 of the driver 108 reaches a maximum rearward position, which brings the anvil end 110 closest to the air cylinder piston rod 130. The driver rearward motion stop 154 is fixedly attached along the driver 108 as shown. This maximum rearward position is enforced when the fixedly attached driver rearward motion stop 154 abuts against the rearward lower bushing 126.

The distance between the air cylinder piston rod 130 and the anvil end 110 of the driver 108, when the air cylinder piston rod 130 is in the retracted position, and the driver 108 is in the most rearward position, is called the acceleration distance 406 (shown in FIG. 4). The driver 108 includes the driver rearward motion stop 154 that limits the rearward motion of the driver 108. Therefore, the driver rearward motion stop 154 sets the acceleration distance 406 between the air cylinder piston rod 130 and the anvil end 110 of the driver 108.

In some embodiments, the acceleration distance 406 (shown in FIG. 4), is substantially 1 inch, the distance over which the air cylinder piston rod 130 accelerates to gain momentum and speed.

In this embodiment, the energy absorbing spring 152 resiliently absorbs the energy of forward motion of the driver 108 after an impact of the air cylinder piston rod 130 onto the anvil end 110 of the driver 108. Upon being compressed, the energy absorbing spring 152 releases compression energy, thereby reversing the direction of motion of the driver 108. The energy absorbing spring 152 prevents the anvil end 110 of the driver 108, during a forward motion, from striking the rearward lower bushing 126 in the event of a “dry fire”. A “dry fire” can occur when the air cylinder piston rod 130 extends to a forward position without the blade 114 (shown in FIG. 1) engaging with roofing materials.

The forward travel of the driver 108 is limited by the fully compressed length of energy absorbing spring 152. When the energy absorbing spring 152 is fully compressed, the distance between the driver rearward motion stop 154 (which is fixedly attached along the driver 108) and the forward lower bushing 126 is the same as the length of the fully compressed spring 152. The spring 152 always resides between the rearward lower bushing 126 and the forward lower bushing 126.

The distance between the anvil 110 and the driver rearward motion stop 154 (affixed to the driver 108) is determined such that when the spring 152 is fully compressed, the anvil 110 does not reach the rearward lower bushing 126.

The driver 108 is free to slide with respect to the bushings 126.

When the blade 114 meets resistance on the roof, and the user pushes forward on the handle assembly 118, the driver 108 is pushed to the rear, the user can then push the push-button valve 148 to engage the nails. If the user continues to leave the push-button valve 148 in the depressed position, the blade 114 will remain forward.

When the spring 152 is fully compressed, and the forward spring washer 206 abuts against the forward lower bushing 126, the end of the air cylinder piston rod 130 will not make contact with the anvil 110. This allows the momentum travel of the blade 114 to exceed the length of the stroke of the air cylinder 128. To prevent damage to the rearward lower bushing 126, the spring prevents the anvil 110 from striking the rearward lower bushing 126.

In some embodiments of the pneumatic roofing material removal tool 100, an external air compressor (not shown) is used to provide compressed air at a rate of at least 5.0 CFM (cubic feet per minute) at a pressure of 90 PSI (pounds per square inch).

In preferred embodiments, components sized with port and connection sizes of at least ⅜ inch diameter NPT may include at least one of: the single acting pneumatic cylinder 128, the quick-connect air fitting 134, the air control valve 136, the main air feed hose 140, and the air cylinder hose 142. The pilot feed tube 144 is connected to the pneumatic accumulator 132 using a ⅛ inch NPT half couple welded onto one face of the pneumatic accumulator 132 to supply high pressure air to the push-button valve 148.

For use with some embodiments, the compressed air supply hose (not shown) that is to be attached to the quick-connect air fitting 134, has a hose inside diameter of at least ⅜ inch, and the quick-connect air fitting 134 would be screwed into a ⅜ inch NPT port.

In some embodiments, the single acting pneumatic cylinder 128 has a diameter that is substantially 2 inches, and the ports at the air cylinder piston rod 130 end of the single acting pneumatic cylinder 128 have a diameter of at least ¼ inch. The ports are ¼ inch due to physical space constraints within the forward head. Two ¼ inch ports are used in tandem so as to compensate for their relatively smaller size, and these ¼ inch ports are located 180 degrees apart.

In some embodiments, the air cylinder piston rod 130 is at least 6 inches in length. In some embodiments, the air cylinder piston rod 130 is substantially ⅝ inches in diameter. In some embodiments, the air cylinder piston rod 130 is made of stainless steel.

The air cylinder piston rod 130 is accelerated by high pressure compressed air so that the air cylinder piston rod 130 gains momentum, and that momentum is transferred at impact to the anvil end 110 of the driver 108.

An internal restoring spring 512 (shown in FIG. 5) within the single acting pneumatic cylinder 128 provides a restoring force during a retracting stroke. Compressed air is not used to provide a restoring force during the retracting stroke of the single acting pneumatic cylinder 128.

Also, the weight of the components behind or near the rear handle 158 provides better balance of the tool, and provides for easier control by the user of the blade 114 (shown in FIG. 1) of the pneumatic roofing material removal tool 100.

In preferred embodiments, the external air compressor provides compressed air at a constant rate of substantially 5.0 CFM at 90 PSI of continuous air pressure to the pneumatic roofing material removal tool 100. In some embodiments, the external air compressor can provide compressed air at a constant rate of substantially 5.0 CFM at 150 PSI of continuous air pressure to the pneumatic roofing material removal tool 100. In preferred embodiments, for the operation of three pneumatic roofing material removal tools 100, the external air compressor provides at least 12.0 CFM at 90 PSI of continuous air pressure.

The power of the impact that the pneumatic roofing material removal tool 100 delivers via the blade 114 is easily adjusted by adjusting the air pressure supplied to the tool 100. Without adequate air pressure available to the tool 100, the pneumatic roofing material removal tool 100 will not operate properly.

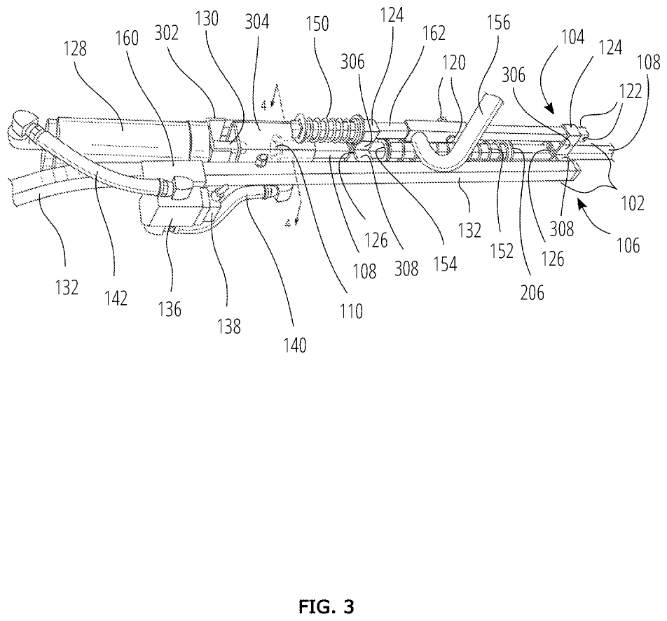

With reference to FIG. 3, a perspective close-up view of the embodiment of FIG. 1 is shown, featuring a U-shaped pneumatic cylinder mounting bracket 302 fixedly attached to the lower portion of the frame 106. The single acting pneumatic cylinder 128 is fixedly mounted on the U-shaped pneumatic cylinder mounting bracket 302.

In this embodiment, a collision protection box 304 is shown at least partially enclosing the anvil end 110 of the driver 108. The anvil end 110 of the driver 108 and part of the air cylinder piston rod 130 are shown in a hidden view with dotted lines. The collision protection box 304 protects the user from small amounts of debris being ejected by the impact of the air cylinder piston rod 130 against the anvil end 110 of the driver 108. The collision protection box 304 also protects the body parts of the user, such as the fingers of the user from being injured by the forceful impact of the air cylinder piston rod 130 against the anvil end 110 of the driver 108. The collision protection box 304 also prevents work-site materials from entering the area between the air cylinder piston rod 130 and the anvil end 110 of the driver 108.

The upper bushings 124 are secured to the lower bushings 126 using upper brackets 306, and the lower bushings 126 are secured to both sides of the lower frame 106 using lower brackets 308 that connect to each side of the lower frame 106.

With reference to FIG. 4, a top cross-sectional view of the lower portion of the frame 106 is shown, featuring the U-shaped pneumatic cylinder mounting bracket 302 and the collision protection box 304, both fixedly attached to the lower portion of the frame 106. In this embodiment, the U-shaped pneumatic cylinder mounting bracket 302 is attached to the lower portion of the frame 106 by at least one weld 402, and the collision protection box 304 is attached to the lower portion of the frame 106 by at least one weld 404.

Also shown is the air cylinder piston rod 130 in both a retracted position (solid lines) and an extended position (dotted lines). In the retracted position, the air cylinder piston rod 130 is not in contact with the anvil end 110 of the driver 108 (solid lines).

When the air cylinder piston rod 130 is in the retracted position (solid lines) and the anvil end 110 of the driver 108 is in the rear-most position (solid lines), the distance between the air cylinder piston rod 130 and the anvil end 110 of the driver 108 is called the acceleration distance 406, i.e., the distance over which the air cylinder piston rod 130 accelerates before impacting upon the anvil end 110 of the driver 108. The use of a heavy internal piston weight 506 (shown in FIG. 5) rather than a standard internal piston weight increases the power of the impact of the air cylinder piston rod 130 upon the anvil end 110 of the driver 108.

When the air cylinder piston rod 130 reaches the extended position (shown in dotted lines), which occurs after the air cylinder piston rod 130 has been driven forward after the impact of the air cylinder piston rod 130 upon the anvil end 110 of the driver 108, the anvil end 110 of the driver 108 also reaches a forward position (shown in dotted lines), relative to the lower portion of the frame 106.

The anvil end 110 is shown with an optional washer 408. In other embodiments, the washer 408 is not included on the anvil end 110. Instead, the anvil end 110 has a square solid end that is created by inserting, welding, and grinding a square solid piece of steel.

With reference to FIG. 5, a cross-sectional view of a single acting pneumatic cylinder 502 is shown having a heavy internal piston 506 (e.g. a brass piston weighing 0.5 pounds) and an internal restoring spring 512. Also shown is an air cylinder piston rod 508 and a mounting thread 510 configured to attach the single acting pneumatic cylinder 502 to the pneumatic roofing material removal tool 100 (shown in FIG. 1). The heavy internal piston 506 is configured to increase the momentum transfer impact of the air cylinder piston rod 508 upon the anvil end 110 of the driver 108 (shown in FIG. 1) as compared with a standard piston.

In some embodiments, the air cylinder piston rod 508 is at least 6 inches in length. In some embodiments, the air cylinder piston rod 508 is substantially ⅝ inches in diameter. In some embodiments, the air cylinder piston rod 508 is made of stainless steel.

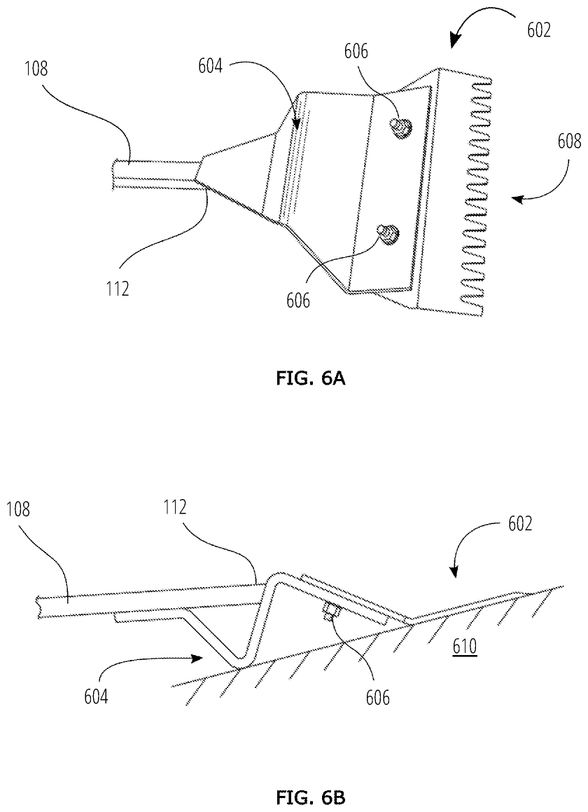

Referring to FIG. 6A, a perspective bottom view of a blade 602 embodiment having a fulcrum-shaped base 604 is shown, featuring the driver 108, the blade end of the driver 112, the blade 602, a plurality of teeth 608, and at least one bolt 606 used to attach the blade 602 to the fulcrum-shaped base 604. The fulcrum-shaped base 604 is attached to the blade end of the driver 112.

Referring to FIG. 6B, a side view of the blade 602 embodiment with the fulcrum-shaped base 604 is shown, featuring the driver 108, the blade end of the driver 112, the blade 602, and at least one bolt 606 used to attach the blade 602 to the fulcrum-shaped base 604. The fulcrum-shaped base 604 is attached to the blade end of the driver 112. The fulcrum-shaped base 604 is shown resting against a roof surface 610. After a user wedges the blade 602 under at least one layer of roofing material, the fulcrum-shaped base 604 can be used to pry up the roofing material as the user presses the driver 108 downward, which causes the blade 602 to move upward due to pivoting about the fulcrum-shaped base 604.

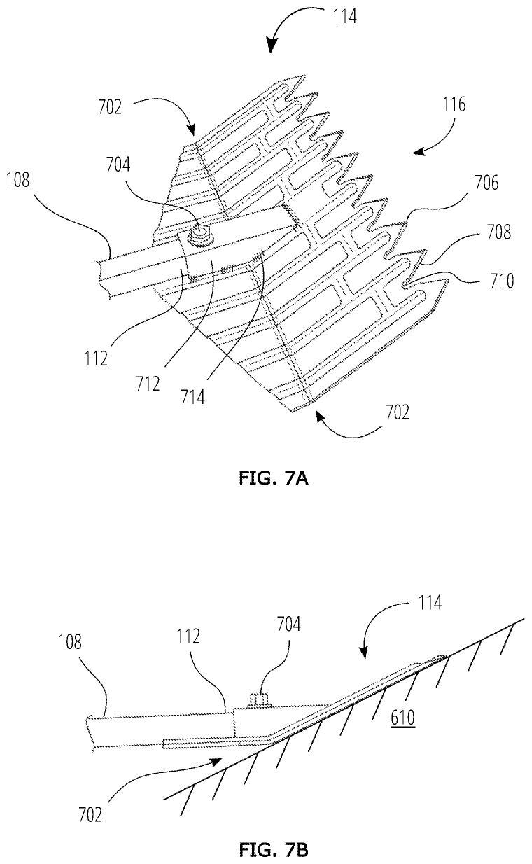

With reference to FIG. 7A, a perspective bottom view of the blade 114 embodiment with a fulcrum-shaped base 702 is shown, featuring the driver 108, the blade end of the driver 112, the blade 114, with the plurality of teeth 116. A bolt 704 attaches the blade 114 to a blade support 712 that is attached to the fulcrum-shaped base 702 using a plurality of welds 714. Each tooth of the plurality of teeth 116 has a slightly rounded point 706. Each tooth of the plurality of teeth 116 has a beveled edge on each side of the slightly rounded point 706. The beveled edges 708 enable the teeth 116 to better slide under the head of a nail, such as the first nail 802 and the second nail 804 (shown in FIG. 8A) embedded in the roof surface 610 (shown in FIG. 7B). Included between each pair of teeth of the plurality of teeth 116 are a plurality of semi-circular notches 710 that are shaped so as to receive the shanks of roofing nails that extend into the roof from the head of each nail embedded in the roof.

When the roof's underlayment consists of a material that resists removal of nails, and the shingles are fastened down tightly, or when the nails are actually imbedded into the shingle material, the nails can be much more difficult to remove. The problem then becomes not lifting the shingles and nails, but rather getting under the shingles and nails to remove them. The embodiment of the blade 114 can successfully address this normally problematic situation.

The slot 710 at the base of each tooth 116 is slightly wider than the nail shank, so as to get a better grip on the bottom of the nail head. If you don't get a secure grip on the nail head, when the user attempts to pry the nail out of the roof, the nail head will bend, and then the nail becomes more difficult to remove.

Further, the point 706 of each tooth 116 has been slightly rounded, and the edges 708 on each side of each tooth 116 has been slightly beveled. Consequently, the user will not hit a nail head with a flat edge as is sometimes found on the teeth of roofing tools. Nor will the teeth have sharp points that tend to accidentally dig into the material under the shingles before reaching a nail.

With reference to FIG. 7B, a side view of the blade 114 embodiment of the blade of FIG. 7A is shown, featuring the driver 108, the blade end of the driver 112, the blade 114, and the bolt 704 used to attach the blade 114 to the fulcrum-shaped base 702. The fulcrum-shaped base 702 is shown upon a roof surface 610. After a user wedges the blade 114 under at least one layer of roofing material, such as a first shingle 806 and a second shingle 808 (shown in FIG. 8E), the fulcrum-shaped base 702 is used to pry up the roofing material as the user pushes the driver 108 downward, which forces the blade 114 upward by pivoting about the fulcrum-shaped base 702.

With reference to FIGS. 8A, 8B, 8C, 8D, and 8E, a typical usage sequence is shown of the pneumatic roofing material removal tool 100 as a user (not shown) removes a first nail 802, and then a first shingle 806, and then a second nail 804, and finally a second shingle 808 from the roof surface 610.

With reference to FIG. 8A, a side view is shown of the pneumatic roofing material removal tool 100 with the blade 114 positioned on the roof surface 610. The leading edge of the blade 114 has a plurality of teeth 116. The plurality of teeth 116 are shown just reaching the first shingle 806 and the first nail 802, first meeting resistance.

To use the pneumatic roofing material removal tool 100, the user first grasps the forward handle 156 and the rear handle 158. Before actuating the tool 100, the recoil-absorbing spring 150 is in a semi-compressed position, held in position by the rearward motion stop 122. The air cylinder piston rod 130 is in the retracted position, creating an acceleration distance 406 between the air cylinder piston rod 130 and the anvil end 110 of the driver 108. The driver 108 is fixedly attached to both the anvil end 110 of the driver 108 and the blade support 712. The blade end of the driver 112 is attached to the blade support 712 by a bolt 704. The blade support 712 is fixedly attached to and supports the blade 114. The anvil end 110 of the driver 108, driver 108, and the blade 114 are shown in the mostly leftward position relative to the frame 102, as is typical just before the single acting pneumatic cylinder 128 is activated. The energy absorbing spring 152 is shown uncompressed.

With reference to FIG. 8B, a side view is shown of the pneumatic roofing material removal tool 100 after the user has pressed the push-button valve 148 (shown in FIG. 1). The blade 114 is still resting on the roof surface 610, but the plurality of teeth 116 have been forced partially under the first shingle 806, and the blade 114 has engaged with the first nail 802.

By pressing the push-button valve 148, the user activated the forward stroke of the single acting pneumatic cylinder 128, which partially extended the air cylinder piston rod 130. The air cylinder piston rod 130 accelerated through the acceleration distance 406 (shown in FIG. 4 and FIG. 8A) and very forcefully impacted upon the anvil end 110 of the driver 108. The forceful impact moved the driver 108 to the right, which shoved the plurality of teeth 116 partially under the first shingle 806, which partially pried up the first nail 802.

With reference to FIG. 8C, a side view is shown of the pneumatic roofing material removal tool 100 after the user has tilted the pneumatic roofing material removal tool 100 downward by pressing down on the rear handle 158, while keeping the push-button valve 148 depressed. When the user tilted the pneumatic roofing material removal tool 100 downward, the fulcrum action of the fulcrum-shaped base 702 caused the plurality of teeth 116 to lift upward and away from the roof surface 610. The upward movement of the plurality of teeth 116 pried the first nail 802 and the first shingle 806 upward from the roof, and have pried the second nail 804 and the second shingle 808 partially away from the roof surface 610.

With reference to FIG. 8D, a side view is shown of the pneumatic roofing material removal tool 100 after the user has again pressed the push-button valve 148. The blade 114 is still resting on the roof surface 610, but the plurality of teeth 116 have been forced beyond the first shingle 806 to reach partially under the second shingle 808. Also, the blade 114 has engaged with the second nail 804, and the first nail 802 has moved further upward than was shown in FIG. 8C, the first nail 802 now being fully pried away from the roof surface 610.

By pressing the push-button valve 148 a second time, the user activated the forward stroke of the single acting pneumatic cylinder 128, which fully extended the air cylinder piston rod 130.

The user keeps the push-button valve 148 depressed, thereby keeping the air cylinder piston rod 130 fully extended. When pressed the second time, the air cylinder piston rod 130 rapidly and forcefully moved the driver 108 to the right, moving the energy absorbing spring 152 into a compressed position.

With reference to FIG. 8E, a side view is shown of the pneumatic roofing material removal tool 100 with the blade 114 tilting upward from the roof surface 610. The user continues to depress the push-button valve 148 (shown on FIG. 1) and therefore the air cylinder piston rod 130 continues to be fully extended.

The user has also tilted the pneumatic roofing material removal tool 100 into a further downward position (compared to that shown in FIG. 8C) by pressing further downward on the rear handle 158. The fulcrum action of the fulcrum-shaped base 702 has lifted the plurality of teeth 116 further upward and away from the roof surface 610. The upward tilting of the blade 114 and the plurality of teeth 116 has lifted the first shingle 806, the second shingle 808, the first nail 802, and the second nail 804 away from the roof surface 610.

When using a manual roofing material removal tool, the user must repeatedly move the manual tool out from under the shingles to gain enough distance to forcefully accelerate the manual tool forward, and again must forcefully push the manual roofing tool under the shingles.

However this manual back-and-forth movement is not necessary when using the pneumatic roofing material removal tool 100. Once the blade 114 is under the shingles, the user can simply press the push-button valve 148 again to further move the blade 114 forward so as to further engage the singles and the nails.

Once the anvil end 110 of the driver 108 is in the forward position, the blade 114 will typically remain engaged with the roofing materials, and the pneumatic roofing material removal tool 100 will not need to be withdrawn from the shingles, saving great effort by the user. The user can then simply pry the roofing materials up from the roof surface 610, and the user may also move the roofing materials down a slope of the roof surface 610 to clear the roofing materials away. Therefore, maintaining the push-button valve 148 in a depressed position with the blade 114 in an extended position can result in easier removal of the roofing materials.

The blade 114 with the push-button valve 148 depressed provides a positively pushed forward blade 114 that is resistant to being pushed backwards when the roofer applies forward pressure to the handle 156.

To illustrate how the pneumatic roofing material removal tool 100 can be used on a typical roof replacement job, the following example is offered.

The roofer intends to remove the roofing material of a typical roof section, where the roof cap at the top of this roof section has already been removed and disposed of.

The roofer will typically start on the edge of the roof, and go down the roof in parallel paths from one side to the other, and then back across repeatedly, until he/she gets down to the bottom of the roof section.

To use the tool 100, with the compressor hooked up and the air pressure suitably adjusted, the roofer inserts the blade 114 under the roofing material without pressing the push button 148. He continues to move down the roof until the blade meets resistance, depresses the push button 148, which activates the tool 100, thereby driving the blade 114 under the roofing material, engaging the nails. With the push button 148 still depressed, he pushes the handle 156 in a downward direction lifting the shingles and nails from the surface. With the shingles and nails still on top of the tool 100, the roofer continues to push forward, keeping the blade 114 on the roof under the shingles, pressing down on the roofing material under his tool 100, after releasing the push button 148.

He advances down the roof until he meets resistance, then depresses the push button 148 to again activate the tool 100, while remaining under the material to be removed, getting under the material and securing nails, he holds the push button 148 in the depressed position until he has lifted the material and nail out of the roof.

He continues down the roof, repeating the cycle of material removal as he goes, for as many courses as he cares to. Eventually he will have too much material on top of his tool 100 to advance easily. He then pulls the tool 100 out from under the roofing material and starts down a parallel path, approximately a blade width, in the direction he is moving across the roof. He continues doing this until he has removed as much material as he cares to in that direction. He now starts down the next several courses, or returns to the side he started on to allow someone else to remove or move the removed material out of his way. He may alternatively use the pneumatic roofing material removal tool 100 to move material down the roof.

Other modifications and implementations will occur to those skilled in the art without departing from the spirit and the scope of the invention as claimed. Accordingly, the above description is not intended to limit the invention, except as indicated in the following claims.

1. A pneumatic roofing material removal tool for use by a roofer when removing roofing material from a roof, the tool comprising:
a driver having a blade end and an anvil end, such that any impacts upon the anvil end of the driver are transmitted to the blade end of the driver;
a blade configured to be wedged under at least one layer of roofing material, the blade being in rigidly connected constant-angled relationship with the blade end of the driver, and the blade being shaped so as to include a pivoting fulcrum that is configured to enable the blade to pry up the at least one layer of roofing material whenever the anvil end of the driver is pressed downward;
a single-acting pneumatic cylinder configured to apply forceful impacts to the anvil end of the driver, the single-acting pneumatic cylinder including a heavy piston weighing at least 0.5 pounds;
a handle assembly configured to be gripped by a user, and configured such that when the user presses downward on the handle, the anvil end of the driver is pressed downward; and
a frame having:
an upper portion in slidable relationship with the handle assembly, and
a lower portion slidably supporting the driver, and fixedly supporting the single-acting pneumatic cylinder.

2. The pneumatic roofing material removal tool of claim 1, wherein the lower portion of the frame includes at least two lower bushings that slidably support the driver.

3. The pneumatic roofing material removal tool of claim 1, wherein the lower portion of the frame includes at least one spring configured to resiliently absorb energy of forward motion of the driver after impact, and then reverse the forward motion of the driver, the at least one spring, when in an uncompressed state, being of a length that is less than a distance separating two lower bushings that support the driver.

4. The pneumatic roofing material removal tool of claim 1, wherein the driver has a rearward motion stop that is configured to limit the rearward motion of the driver.

5. The pneumatic roofing material removal tool of claim 1, wherein the upper portion of the frame includes at least two upper bushings that slidably support the handle assembly.

6. The pneumatic roofing material removal tool of claim 5, wherein the handle assembly includes at least one beam with a non-circular cross section disposed within the at least two upper bushings.

7. The pneumatic roofing material removal tool of claim 1, wherein the handle assembly includes at least one recoil-absorbing spring configured to resiliently absorb rearward motion of the frame.

8. The pneumatic roofing material removal tool of claim 1, wherein the handle assembly has a rearward motion stop that is configured to limit rearward motion of the handle assembly.

9. The pneumatic roofing material removal tool of claim 1, wherein the frame has at least one mounting fixture for at least one air control valve.

10. (canceled)

11. The pneumatic roofing material removal tool of claim 1, further including:
a pneumatic accumulator configured to store high pressure air, the pneumatic accumulator being in fluid communication with the single-acting pneumatic cylinder.

12. The pneumatic roofing material removal tool of claim 11, wherein at least some part of the lower portion of the frame functions as the pneumatic accumulator.

13. The pneumatic roofing material removal tool of claim 1, wherein the frame includes a collision protection box that at least partially encloses the anvil end of the driver.

14. (canceled)

15. The pneumatic roofing material removal tool of claim 1, wherein the blade has a plurality of teeth.

16. The pneumatic roofing material removal tool of claim 1, wherein the blade is removable.

17. The pneumatic roofing material removal tool of claim 1, wherein the blade has a pivoting fulcrum-shaped base.

18. (canceled)
